(19) United States
(12) Patent Application Publication
(10) Pub. No.: US 2008/0212755 A1
(43) Pub. Date: Sep. 4, 2008

(54) GRAPHICAL USER INTERFACE FOR TELEPHONY DEVICE

(75) Inventor: Peter Francis Couse, Ottawa (CA)

Correspondence Address: INTER-TEL (DELAWARE), INC.;A MITEL COMPANY, 7300 WEST BOSTON STREET, CHANDLER, AZ, 85226, US

(73) Assignee: MITEL NETWORKS CORPORATION, Ottawa (CA)

(21) Appl. No.: 11/681,609

(22) Filed: Mar. 2, 2007

(51) Int. Cl. H04M 3/42

(52) U.S. Cl. 379/201.04

(57) ABSTRACT

For use with a telephony application executed within a computer having a screen display, the improvement comprising displaying a tool bar having at least one context sensitive button within a task bar on the screen display, wherein the tool bar is located so as not to overlap any application windows displayed on the screen display.

### BACKGROUND OF THE INVENTION

1. Field of the Invention

The present invention is directed to telephony devices, and more particularly to a graphical user interface for use on a telephony device.

2. Description of the Related Art

PC based telephony applications are well known in the art, most of which provide a Graphical User Interface (GUI) based on the typical Windows® method of display (i.e. the application GUI appears in a window on the PC screen similar to all of the other applications on the screen). Because telephony applications operate within standard application windows, they behave in the same manner, namely when the application is active or in focus, its window covers up other application windows on the user's screen. This method of operation has been designed around a methodology that assumes that the user decides which window (application) they want to have active or on top of other windows.

Telephony applications differ from most other applications on a PC because of the ‘real time’ nature of telephony. With a telephony application, the user does not control when a phone call arrives. The phone call is an interruption to an existing activity in which the user is involved. Because of this difference in application behavior, telephony applications that use the standard “Windows” approach exacerbate the user's awareness of having been interrupted because the GUI window typically opens over top of the application that the user is currently using. This is very disruptive to the user and may lead to user annoyance in the way the telephony application behaves.

Attempts have been made to reduce the obtrusiveness of incoming calls by using a “toast pop” window (i.e. a small window that “pops up” at the bottom right hand corner of the user's screen). This window typically contains caller ID information for the caller and a method for answering the call (e.g. a button or link that, when clicked, answers the call). Once the user has answered the call, a telephony control window opens that provides access to call control features that the user may need to handle the call (e.g. transfer, conference, hold, hang up, etc). However, once the telephony control window opens it typically obscures other windows open on the user's PC screen thereby disrupting the user's activities in connection with such obscured windows. Often, the user requires access to the telephony call control features while continuing to work on tasks requiring access to the underlying or obscured windows (i.e. the applications the user was focusing on prior to interruption by the telephone call). Toggling back and forth between windows can be both confusing and time consuming and makes call handling difficult while accessing features of underlying application windows.

### SUMMARY OF THE INVENTION

According to the present invention, a telephony application GUI is provided for display on a computer such as a PC or laptop, that does not cover up any existing application windows when a call is received or when the user wishes to place a call or manage an existing call. The application GUI remains visible and accessible to the user regardless of what application the user is currently using. In this way, the obtrusiveness of incoming calls is minimized, eliminating much of the annoyance that users associate with existing telephony applications. According to one aspect, the application GUI provides context sensitive buttons for call handling functions that allow the user to easily manage their phone calls. According to another aspect, the telephony application GUI allows the user to look up phone numbers by typing in a contact name that has been stored in a local or networked contact management application, without opening a window for that application. Numbers returned for the contact appear within the application GUI for selection and dialing. According to yet a further aspect, caller ID information is displayed to the user for incoming calls, without the use of a toast pop window. The caller ID information appears within the application GUI and does not cover up any other windows on the user's computer screen.

A person of skill in the art will understand that all references in this specification to PC include any form of computer, such as a laptop, PDA, etc.

The foregoing aspects together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a simplified representation of a communication system having a plurality of computers in connection with which a method is implemented in accordance with an embodiment of the present invention; and

FIG. 2 illustrates a telephony application GUI according to an embodiment of the present invention during a call; and

FIG. 3 illustrates the telephony application GUI according to an embodiment of the present invention upon receipt of an incoming call.

### DETAILED DESCRIPTION OF THE PREFERRED EMBODIMENTS

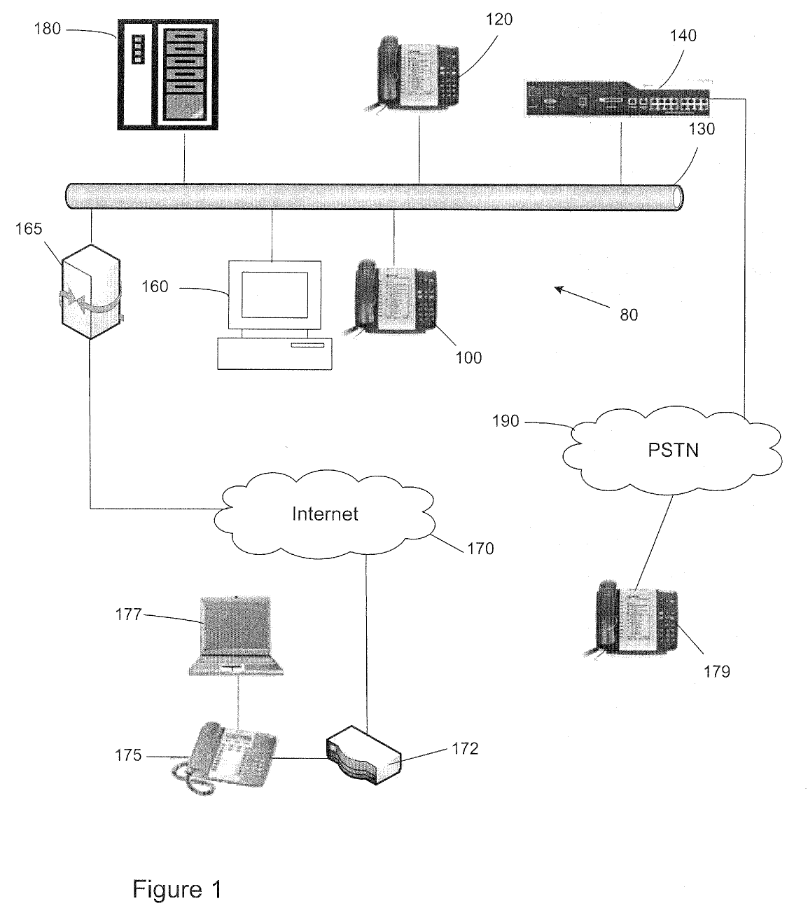

Reference is first made to FIG. 1 showing an enterprise communication system 80 forming an exemplary environment for implementation of the telephony application GUI of the present invention. A first telephone device 100 (i.e. IP phone) of a first user and a second telephone device 120 of a second user are both connected via a local area network 130 to a telephony switch 140 that is responsible for telephony connections between the first telephone device 100 and the second telephone device 120, as well as outside connections to a telephone device 179 over the PSTN 190. The first telephone device 100 is associated with a PC 160 having software for communicating with the telephony switch 140 over LAN 130 (or directly connected to telephony device 100 using suitable APIs), such as a PC based telephony application to control collaborative communication features of the device 100 and PC 160 (e.g. Microsoft® Office Communicator). The user at telephone device 100 uses PC 160 to activate features and specify preferences, in a well known manner.

A gateway 165 connects the LAN 130 to the Internet 170 in a conventional manner to permit VoIP communication with an IP phone 175 connected to a computer 177 that may also execute a telephony application.

A presence server 180 (e.g. Microsoft® LCS, Lotus® SameTime, etc.) may be provided for transmitting presence status information to the telephone devices 100 and 120 and/or the software client on PC 160, relating to the availability of users within the enterprise communication system 80. It will be appreciated by those skilled in the art that the presence server 180 provides presence information by monitoring devices and applications to determine a user's presence.

For the purpose of simplicity, only two telephone devices, the first telephone device 100 and the second telephone device 120, are shown within the enterprise. It will be appreciated that many other telephone devices and additional PCs can be connected to the LAN 130. It will also be appreciated that the telephony switch 140 can be any switch that handles connections between telephone devices.

For the purpose of the present example, the first telephone device 100 is an IP desk telephone connected to the telephony switch 140 via LAN 130. Similarly, the second telephone device 120 is an IP desk telephone locally connected to the telephony switch 140 via LAN 130, whereas telephone devices 175 and 179 are remotely located and may be connected to the telephony switch 140 over the Internet (via a VPN connection), and PSTN 190, respectively. Moreover, the LAN 130 may be replaced by any suitable communications network, including the Internet, corporate Intranet, cellular network, etc.

As discussed above, one or more of the computers 160, 177, etc., within system 80, execute call control software in connection with which the application GUI of the present invention may be provided.

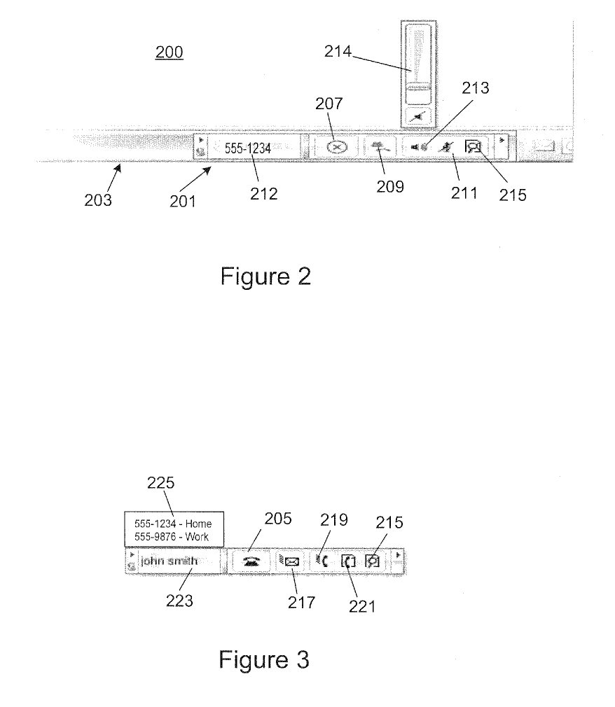

FIGS. 2 and 3 show a portion of a screen 200 for a computer 160, 177, etc., on which an embodiment of the telephony application GUI of the present invention is implemented. The GUI is not “windows” based, in that it does not cover up the user's existing window when a call arrives or when the user wishes to place a call or manage an existing call. Rather, the exemplary application GUI is in the form of a Windows Toolbar 201 that resides in the user's Windows task Bar 203 (typically located at the bottom of the user's screen). The application GUI is always visible and accessible to the user regardless of what application the user is currently using.

The telephony application GUI provides a number of context sensitive telephony control buttons (dedicated buttons that are typically found on business phones). Context sensitive means that the buttons presented change function based on the call state. For example, during a call (FIG. 2), the application GUI may provide control buttons such as End Call 207, Hold 209, Mute 211, Caller ID 212, Volume Control 213 which when pressed causes a Volume Control Slider 214 to open, and Search Desktop 215 for returning a list of files and/or emails that contain the caller's name or number, etc. In the idle (i.e. no call) state (FIG. 3), the application GUI may provide control buttons such as Make Call 205, Voice Mail 217, Lookup Caller Contact Record 219, and Access Missed Calls List 221. Also, the user may enter a contact name 223 for lookup, which returns contact phone numbers 225 to be displayed (e.g. accessed from a contact manager such as Microsoft® Outlook).

The many features and advantages of the invention are apparent from the detailed specification and, thus, it is intended by the appended claims to cover all such features and advantages of the invention that fall within the true sphere and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. For use with a telephony application executed within a computer having a screen display, the improvement comprising displaying a tool bar having at least one context sensitive button within a task bar on said screen display, said tool bar being located so as not to overlap any application windows displayed on said screen display.

2. The improvement of claim 1, wherein said at least one context sensitive button emulates operation of a physical button on a phone associated with said computer.

3. The improvement of claim 2, wherein said at least one context sensitive button is a Make Call button.

4. The improvement of claim 2, wherein said at least one context sensitive button is an End Call button.

5. The improvement of claim 2, wherein said at least one context sensitive button is a Hold button.

6. The improvement of claim 2, wherein said at least one context sensitive button is a Mute button.

7. The improvement of claim 2, wherein said at least one context sensitive button is a Redial button.

8. The improvement of claim 2, wherein said at least one context sensitive button is a Volume button which when activated causes a Volume Control Slider to be displayed.

9. The improvement of claim 1, wherein said tool bar further includes a text entry field for entry of a contact name for searching and display of associated contact phone numbers.

10. The improvement of claim 1, wherein said tool bar further displays caller ID information.
